(19) United States
(12) Patent Application Publication
(10) Pub. No.: US 2007/0146601 A1
(43) Pub. Date: Jun. 28, 2007

(54) Liquid crystal panel having protection layer for pixel electrode thereof

(75) Inventor: Jian-Jhong Fu, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/644,327

(22) Filed: Dec. 22, 2006

(30) Foreign Application Priority Data
Dec. 23, 2005 (TW) 94146280

(51) Int. Cl. G02F 1/1333

(52) U.S. Cl. 349/138; 349/43

(57) ABSTRACT

An exemplary crystal panel (100) includes a first substrate (110), a second substrate (120) having a common electrode (121), and a liquid crystal layer (130) interposed therebetween. The first substrate defines a plurality of pixel regions. Each of the pixel regions includes a thin film transistor (140), a protection layer (170), a passivation layer (150), a pixel electrode (160). The thin film transistor includes a source (142), a gate (141), and a drain (143). The protection layer is formed at the gate insulating layer at a position corresponding to the drain. The passivation layer is formed at the thin film transistor, and the passivation layer has a contact hole (148) at position corresponding to the drain. The pixel electrode is formed at the passivation layer and the pixel electrode contacts the drain via the contract hole.

### FIELD OF THE INVENTION

The present invention relates to liquid crystal panels of liquid crystal displays, and more particularly to a liquid crystal panel of a liquid crystal display configured to provide a protection layer for improving the connection between a drain and a pixel electrode thereof.

### GENERAL BACKGROUND

A typical liquid crystal display (LCD) generally includes a liquid crystal panel and a backlight module. The liquid crystal panel includes a first substrate with a plurality of pixel electrodes, a second substrate with a common electrode, and a liquid crystal layer interposed between the substrates. Each pixel electrode is controlled by a respective adjacent thin film transistor (TFT) that is also formed on the first substrate.

Referring to FIG. 4, this is a schematic side view of a conventional liquid crystal display 1. The liquid crystal display 1 includes a liquid crystal panel 2, and a backlight module 3 arranged under the liquid crystal panel 2. The backlight module 3 provides light that illuminates the liquid crystal panel 2, so that the liquid crystal panel 2 can display images.

Referring to FIG. 5, this is an enlarged, cross-sectional view of part of the liquid crystal panel 2. The liquid crystal panel 2 includes a first substrate 10, a second substrate 20 substantially parallel to the first substrate 10, and a liquid crystal layer 30 interposed between the first and second substrates 10, 20.

The first substrate 10 includes a plurality of pixel regions. At each pixel region, the first substrate 10 includes a thin film transistor 40, a passivation layer 50, and a pixel electrode 60. The passivation layer 50 is disposed on the thin film transistor 40, and the pixel electrode 60 is disposed on a part of the passivation layer 50. A common electrode 21 is disposed on the second substrate 20. A potential difference generated between the pixel electrode 60 and the common electrode 21 changes the tilt angle of molecules of the liquid crystal layer 30 at the pixel region. Thereby, a desired amount of light transmits through the pixel region, and the pixel regions cooperatively provide an image that is displayed on a screen of the liquid crystal panel 2.

The thin film transistor 40 includes a gate 41, a gate insulating layer 44, a source 42, a drain 43, and an active layer 45. The gate 41 is disposed on the first substrate 10, and the gate insulating layer 44 made from silicon nitride is disposed on the gate 41 and the first substrate 10. The active layer 45 made from amorphous silicon is disposed on the gate insulating layer 44 above the gate 41. The source 42 and the drain 43 are made from molybdenum, chromium, or aluminum, and are essentially symmetrically opposite to each other, above two sides of the active layer 45 respectively. The source 42 and the drain 43 are insulated from each other. A source contacting layer 46 is formed between one side of the active layer 45 and the source 42. A drain contacting layer 47 is formed between another side of the active layer 45 and the drain 43. The source and drain contacting layers 46, 47 are formed by impurity doping at an upper part of the active layer 45.

The passivation layer 50 is disposed on the source 42, the drain 43, the active layer 45, and the gate insulating layer 44. A contact hole 48 is formed in the gate insulating layer 44 at a position according to the drain 43. The pixel electrode 60 is disposed on the passivation layer 50, and is electrically connected to the drain 43 via the contact hole 48.

Referring to FIG. 6, this is an enlarged view of a circled portion VI of FIG. 5. As seen, a so-called undercut may occur in the gate insulating layer 44. That is, an area of the gate insulating layer 44 may be partially or entirely etched out during an etching process for patterning the drain 43. When this happens, an indentation portion (not labeled) is formed in the gate insulating layer 44. Thus, an opening or improper contact exists as between the pixel electrode 60 and the drain 43. In particular, as seen, the right-hand portion of the pixel electrode 60 is separate from the left-hand portion of the pixel electrode 60 that adjoins the drain 43. As a result, the pixel electrode 60 cannot be controlled by the thin film transistor 40 properly.

Referring to FIG. 7, this is an enlarged, cross-sectional view of the first substrate 10 and associated layers, corresponding to line VII-VII of FIG. 5. The drain 43 has two concave portions (not labeled) at each of opposite sides thereof, due to so-called isotropic etching during an etching process for patterning the layers of the first substrate 10. Part of the passivation layer 50 formed on the gate insulating layer 44 adjacent to the opposite sides of the drain 43 forms a pair of stepped portions (not labeled) at the opposite sides of the drain 43 respectively. The stepped portions are shaped substantially according to the shapes of the concave portions of the opposite sides of the drain 43. The pixel electrode 60 is formed at the drain 43. Therefore, the pixel electrode 60 has two concave portions corresponding to the shapes of the stepped portions of the passivation layer 50. Therefore, an opening or improper contact as between the pixel electrode 60 and the drain 43 can occur at each of the opposite sides of the drain 43.

Accordingly, what is needed is a pixel electrode in a liquid crystal panel of a liquid crystal display configured to overcome the above-described problems.

### SUMMARY

An exemplary liquid crystal panel includes a first substrate, a second substrate having a common electrode, and a liquid crystal layer interposed therebetween. The first substrate defines a plurality of pixel regions. Each of the pixel regions includes a thin film transistor, a protection layer, a passivation layer, a pixel electrode. The thin film transistor includes a source, a gate, and a drain. The protection layer is formed at the gate insulating layer at a position corresponding to the drain. The passivation layer is formed at the thin film transistor, and the passivation layer has a contact hole at position corresponding to the drain. The pixel electrode is formed at the passivation layer and the pixel electrode contacts the drain via the contract hole.

A detailed description of embodiments of the present invention is given below with reference to the accompanying drawings.

### BRIEF DESCRIPTION OF THE DRAWINGS

In the drawings, all the views are schematic.

FIG. 1 is a side cross-sectional view of part of a liquid crystal panel of a liquid crystal display in accordance with a preferred embodiment of the present invention.

FIG. 2 is an enlarged view of a circled portion II of FIG. 1.

FIG. 3 is a cross-sectional view of a first substrate and associated layers of the liquid crystal panel of FIG. 1, corresponding to line III-III thereof.

FIG. 4 is a side view of a conventional liquid crystal display, the liquid crystal display including a liquid crystal panel and a backlight module.

FIG. 5 is an enlarged, cross-sectional view of part of the liquid crystal panel of FIG. 4.

FIG. 6 is an enlarged view of a circled portion VI of FIG. 5.

FIG. 7 is an enlarged, cross-sectional view of a first substrate and associated layers of the liquid crystal panel of FIG. 5, corresponding to line VII-VII thereof.

### DETAILED DESCRIPTION OF PREFERRED EMBODIMENTS

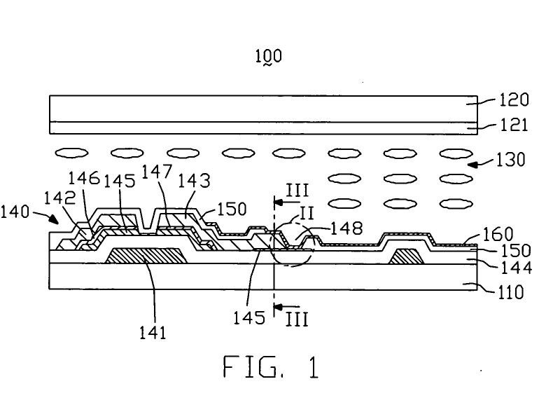

Referring to FIG. 1, this is a side cross-sectional view of part of a liquid crystal panel 100 of a liquid crystal display in accordance with a preferred embodiment of the present invention. The liquid crystal panel 100 includes a first substrate 110, a second substrate 120 substantially parallel to the first substrate 110, and a liquid crystal layer 130 interposed between the first and second substrates 110, 120.

The first substrate 110 includes a plurality of pixel regions. At each pixel region, the first substrate 110 includes a thin film transistor 140, a passivation layer 150, and a pixel electrode 160. The passivation layer 150 is disposed on the thin film transistor 140, and the pixel electrode 160 is disposed on a part of the passivation layer 150. A common electrode 121 is disposed on the second substrate 120. A potential difference generated between the pixel electrode 160 and the common electrode 121 changes the tilt angle of molecules of the liquid crystal layer 130 at the pixel region. Thereby, a desired amount of light transmits through the pixel region, and the pixel regions cooperatively provide an image that is displayed on a screen of the liquid crystal panel 100.

The thin film transistor 140 includes a gate 141, a gate insulating layer 144, a source 142, a drain 143, and an active layer 145. The gate 141 is disposed on the first substrate 110, and the gate insulating layer 144 made from silicon nitride is disposed on the gate and the first substrate 110. The active layer 145 and a protection layer 170 are both made from amorphous silicon, and can be formed simultaneously during a same step in a process of manufacturing the liquid crystal panel 100. The active layer 145 is disposed above the gate insulating layer 144 at a position corresponding to the gate 141. The protection layer 170 is disposed on the gate insulating layer 144 adjacent to the thin film transistor 140. The source 142 and the drain 143 are made from molybdenum, chromium, or aluminum and are essentially symmetrically opposite to each other, above two sides of the active layer 145 respectively. The source 142 and the drain 143 are insulated from each other, and part of the drain 143 is formed on the protection layer 170. A source contacting layer 146 is formed between one side of the active layer 145 and the source 142. A drain contacting layer 147 is formed between another side of the active layer 145 and the drain 143. The source and drain contacting layers 146, 147 are both formed by impurity doping at an upper part of the active layer 145.

The passivation layer 150 is disposed on the source 142, the drain 143, the active layer 145, and the gate insulating layer 144. A contact hole 148 is formed in the gate insulating layer 144 at a position according to the drain 143. The pixel electrode 160 is disposed on the passivation layer 150 and the protection layer 170, and is electrically connected to the drain 43 via the contact hole 148.

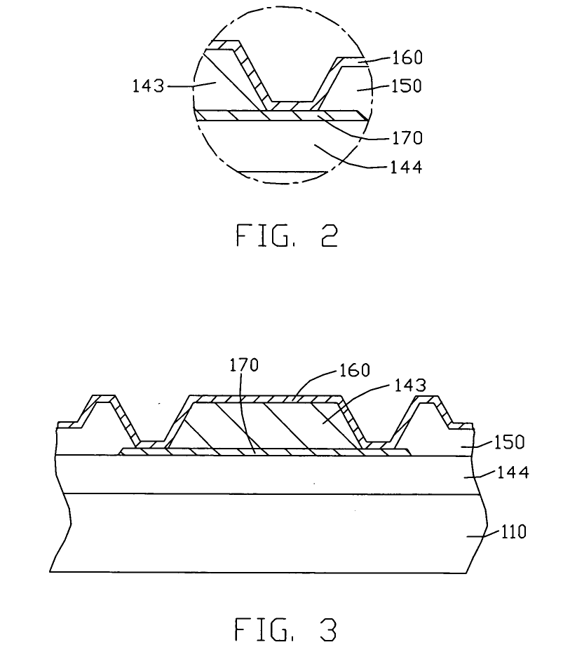

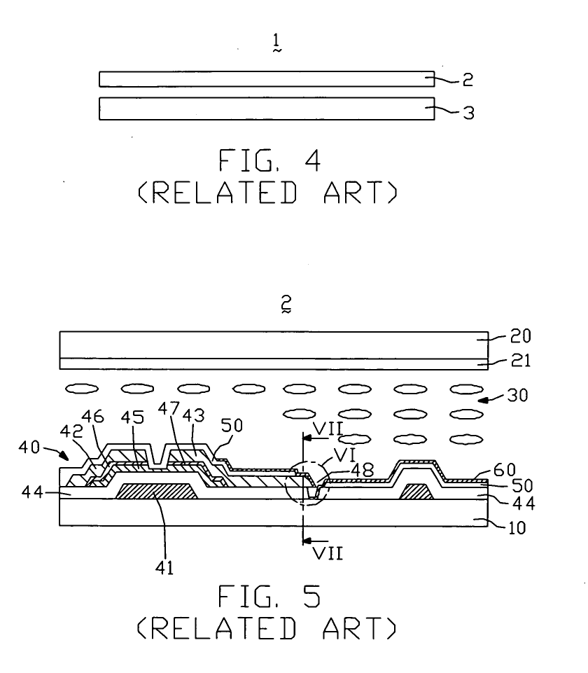

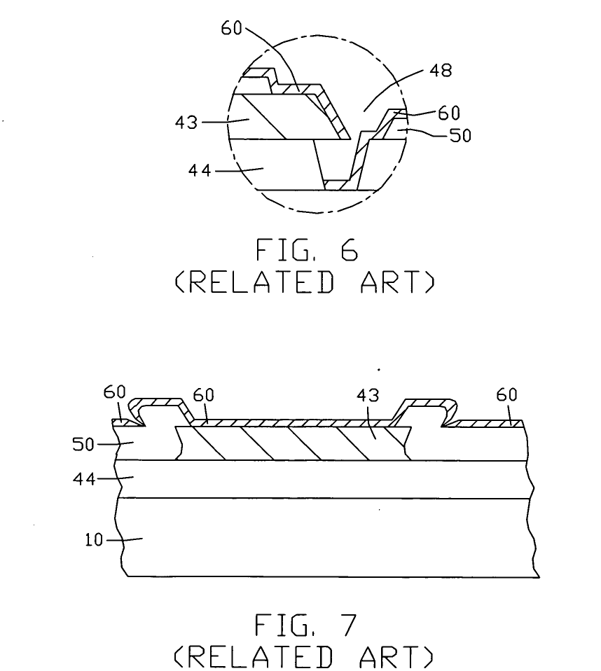

Referring to FIG. 2, this is an enlarged view of a circled portion II of FIG. 1. As seen, the protection layer 170 is not improperly etched at all. That is, during an etching process for patterning the drain 143, the protection layer 170 is not even slightly etched out.

Referring to FIG. 3, this is an enlarged view of the first substrate 110 and associated layers, corresponding to line III-III of FIG. 1. The pixel electrode 160 includes two slopes at each of opposite sides of the drain 143 respectively. The slopes of the pixel electrode 160 are shaped according to corresponding shapes of the side edges of the drain 143.

The side edges of the drain 143 have gentle slopes because a so-called anisotropic etching process is used for forming the drain 143, and the protection layer 170 disposed on the gate insulating layer 144 can protect the gating insulating layer 144 from etching during the anisotropic etching process. Thus a shape of the pixel electrode 160 adjacent to the drain 143 is smooth and continuous, and an opening or improper contact as between the pixel electrode 160 and the drain 143 can be avoided.

While preferred and exemplary embodiments have been described above, it is to be understood that the invention is not limited thereto. To the contrary, the above description is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A liquid crystal panel, comprising:
a first substrate defining a plurality of pixel regions, each of the pixel regions comprising:
a thin film transistor, the thin film transistor comprising a source, a gate, and a drain;
a protection layer formed at the gate insulating layer at a position corresponding to the drain;
a passivation layer formed at the thin film transistor, and having a contact hole at a position corresponding to the drain; and
a pixel electrode formed at the passivation layer, the pixel electrode contacting the drain via the contact hole;
a second substrate comprising a common electrode; and
a liquid crystal layer between the first substrate and the second substrate.

2. The liquid crystal panel as claimed in claim 1, wherein the protection layer is made from amorphous silicon.

3. The liquid crystal panel as claimed in claim 1, further comprising a gate insulating layer formed on the gate.

4. The liquid crystal panel as claimed in claim 3, further comprising an active layer formed at the gate insulating layer at a position according to the source and drain.

5. The liquid crystal panel as claimed in claim 4, further comprising a source contacting layer formed in the active layer at a position according to the source, and a drain contacting layer formed in the active layer at a position according to the drain.

6. The liquid crystal panel as claimed in claim 5, wherein the protection layer and the active layer are made of the same material.

7. A liquid crystal panel, comprising:
a first substrate defining a plurality of pixel regions, each of the pixel regions comprising:
a thin film transistor, the thin film transistor comprising a source, a gate, and a drain;
a protection layer formed at a position corresponding to the drain;
a pixel electrode formed at the thin film transistor, the pixel electrode contacting the drain; and
an active layer formed at the thin film transistor, the active layer and the protection layer being made of the same material;
a second substrate comprising a common electrode; and
a liquid crystal layer interposed between the first substrate and the second substrate.

8. The liquid crystal panel as claimed in claim 7, wherein the active layer and the protection layer are made from amorphous silicon.

9. The liquid crystal panel as claimed in claim 7, further comprising a gate insulating layer formed on the gate.

10. The liquid crystal panel as claimed in claim 9, further comprising an active layer formed at the gate insulating layer at a position according to the source and drain.

11. The liquid crystal panel as claimed in claim 10, further comprising a source contacting layer formed in the active layer at a position according to the source, and a drain contacting layer formed in the active layer at a position according to the drain.

12. The liquid crystal panel as claimed in claim 7, wherein a passivation layer is formed on the thin film transistor.

13. A liquid crystal panel comprising:
a first substrate defining a plurality of pixel regions, each of the pixel regions comprising:
a thin film transistor, the thin film transistor comprising a source, a gate, and a drain;
a protection layer formed at the gate insulating layer at a position corresponding to the drain;
a passivation layer formed at the thin film transistor, and having a contact hole at a position corresponding to the drain; and
a pixel electrode formed at the passivation layer and contacting a protection layer;
a second substrate comprising a common electrode; and
a liquid crystal layer between the first substrate and the second substrate.
